(19) United States
(12) Patent Application Publication
(10) Pub. No.: US 2025/0094715 A1
(43) Pub. Date: Mar. 20, 2025

(54) Standardization Of Text Data In Content Items

(71) Applicant: Oracle International Corporation, Redwood Shores, CA (US)

(72) Inventors: Karempudi V. Ramarao, San Ramon, CA (US); Cody Alan Kingham, Georgetown, TX (US); Rajiv Kumar, Leander, TX (US)

(73) Assignee: Oracle International Corporation, Redwood Shores, CA (US)

(21) Appl. No.: 18/414,144

(22) Filed: Jan. 16, 2024

Related U.S. Application Data
(60) Provisional application No. 63/583,301, filed on Sep. 17, 2023.

(51) Int. Cl. G06F 40/289; G06F 40/253

(52) U.S. Cl. CPC G06F 40/289; G06F 40/253

(57) ABSTRACT

Techniques for standardizing text data are disclosed. The system may identify, within a content item, a target phrase that is to be standardized. A subset of characters of a verb in the target phrase may be selected for comparison to a list of nouns. The subset of characters may be compared to a list of nouns identified in a data corpus. A noun in the list of nouns may be added to a candidate subset of nouns to replace the verb if the noun includes a sequence of characters that matches the subset of characters. A particular noun to replace the verb may be selected from the candidate subset of nouns based on a frequency associated with the particular noun occurring within the data corpus. The system may convert the target phrase to generate a standard phrase at least by replacing the verb with the particular noun.

### INCORPORATION BY REFERENCE; DISCLAIMER

Each of the following applications is hereby incorporated by reference: Application No. 63/583,301, filed on Sep. 17, 2023. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to standardization of text data in content items.

### BACKGROUND

Processing a group of content items may require mining, comparison, and analysis of related sets of text data included in separate content items. However, identifying related sets of text data may be a non-trivial task. As an example, consider an entity processing an application for a role at the entity. Processing the application may require identifying skills that are expressed in skill phrases found within content items pertaining to the application. However, any two content items that pertain to an application may be of different formats, may be written by different authors, may be written from different perspectives, and/or may possess other differences. As a result of the foregoing, two or more skill phrases that recite the same skill may greatly differ.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for standardizing text data in accordance with one or more embodiments;

FIG. 3 illustrates an example set of operations for selecting a substitute noun in accordance with one or more embodiments;

FIG. 4 illustrates an example set of operations for generating a standard phrase in accordance with one or more embodiments; and

FIG. 5 illustrates a block diagram that depicts a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. SYSTEM ARCHITECTURE
3. STANDARDIZING TEXT DATA
4. EXAMPLE EMBODIMENT
4.1 SELECTING A SUBSTITUTE NOUN
4.2 GENERATING A STANDARD PHRASE
5. COMPUTER NETWORKS AND CLOUD NETWORKS
6. MICROSERVICE APPLICATIONS
6.1 TRIGGERS
6.2 ACTIONS
7. HARDWARE OVERVIEW
8. MISCELLANEOUS; EXTENSIONS

### 1. General Overview

One or more embodiments standardize a target phrase in a content item by replacing a verb in the target phrase with a noun based in part on a frequency of the noun in a data corpus. Furthermore, the system may restructure the target phrase based in part on the replacement of the verb with the noun in the target phrase.

In an embodiment, a data corpus may be surveyed to identify words that occur in the data corpus. The data corpus may be selected for survey based on the characteristics of text data included in a content item(s). For example, if a content item is expected to include text data pertaining to a particular subject, a data corpus relating to the particular subject may be surveyed. A list of words identified in a data corpus may be generated. The list of words identified in the data corpus may be organized alphabetically.

In an embodiment, a target phrase that is to be standardized may be identified in a content item. The content item may be any data set containing text data. A target phrase may be identified based on the target phrase including a target word. A “target word,” as referred to herein, refers to a word of a target phrase that may be replaced by a substitute word. A target word may be identified based on the characteristics of the target word, the positioning of the target word within the target phrase, and/or other information. The target word may be added to a list of target words. The list of target words may be organized alphabetically.

In an embodiment, a candidate subset of words to replace a target word may be drawn from a list of words identified in a data corpus. A subset of characters of the target word may be selected for comparison to a word identified in a data corpus. A word that includes a sequence of characters matching the subset of characters may be added to the candidate subset of words. A binary search(es) for a matching word may be executed upon a list of words identified in a data corpus. Multiple candidate subsets of words may be generated for multiple target words based on comparing an alphabetical list of target words to an alphabetical list of words identified in a data corpus. Comparisons between the words in the lists may proceed in a sequence that corresponds to the alphabetical orders of both lists.

In an embodiment, a substitute word identified in a data corpus may be selected to replace a target word. The substitute word may be selected based on the frequency of the substitute word occurring in a data corpus and/or other contextual information pertaining to the target word and/or the substitute word.

In an embodiment, the system may convert a target phrase to generate a standard phrase. As an example, assume that a content item is a résumé of an applicant for a role. In this example, a target phrase in the résumé may be a skill phrase. A “skill phrase,” as referred to herein, includes a set of one or more words that correspond to a human worker's skill. Examples of a skill phrase include “manage a team of engineers” or “assist in clinical trials.” Converting a target phrase to generate a standard phrase may entail replacing a verb in the target phrase with a substitute noun. A substitute noun may be a noun form of the verb. For instance, the system may standardize “assist in clinical trials” to generate “assistance in clinical trials. Additionally, or alternatively, converting a target phrase to generate a standard phrase may involve restructuring the target phrase to conform with a standard phrase structure. Restructuring the target phrase may entail adding a word(s) to the target phrase (e.g., a preposition), reordering the word(s) of a target phrase, removing a word(s) from the target phrase, and/or altering punctuation of the target phrase. For instance, the system may standardize “treat acute pulmonary oedema” to generate “treatment of acute pulmonary oedema.” Standardizing skill phrases across various content items may allow for a comparison of the content items to identify identical or similar skills recited in the content items. For instance, it may be determined that a skill recited in a job requisition is also recited in a résumé.

One or more embodiments described in this Specification and/or recited in the claims may not be included in this General Overview section.

### 2. System Architecture

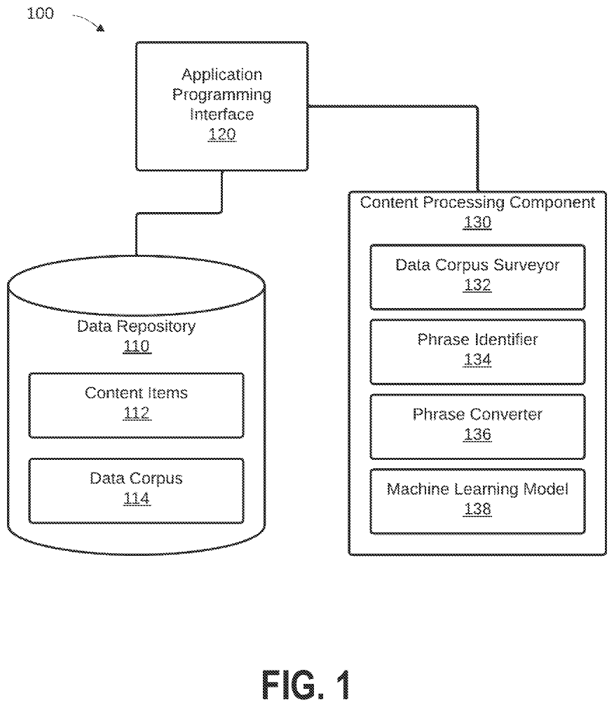

FIG. 1 illustrates a system 100 in accordance with one or more embodiments. In one or more embodiments, system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

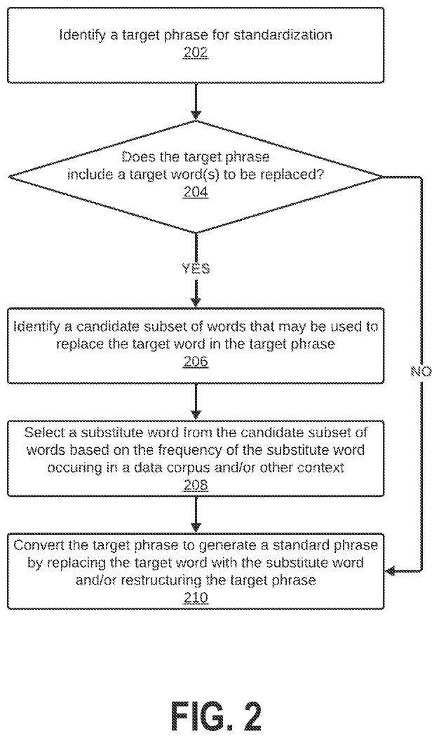

In one or more embodiments, system 100 refers to hardware and/or software configured to perform operations described herein for standardizing text data. For example, a target phrase may express a particular meaning, and system 100 may convert the target phrase to generate a standard phrase for imparting the particular meaning. Examples of operations for standardizing text data are described below with reference to FIG. 2. As illustrated in FIG. 1, system 100 may include data repository 110, application programming interface (API) 120, content processing component 130, and/or other components.

In one or more embodiments, a data repository 110 is any type of storage unit and/or device (e.g., a file system, database, collection of tables, or any other storage mechanism) for storing data. Further, a data repository 110 may include multiple different storage units and/or devices. The multiple different storage units and/or devices may or may not be of the same type or located at the same physical site. Further, a data repository 110 may be implemented or executed on the same computing system as other components of the system 100. Additionally, or alternatively, a data repository 110 may be implemented or executed on a computing system separate from other components of the system 100. The data repository 110 may be communicatively coupled to other components of the system 100 via a direct connection or via a network.

As illustrated in FIG. 1, data repository 110 may include content items 112, data corpus 114, and/or other data. Information describing content items 112 and data corpus 114 may be implemented across any of the components within system 100. However, this information is illustrated within data repository 110 for purposes of clarity and explanation.

In an embodiment, data repository 110 may store content items 112. Content items 112 may contain text data. As an example, consider a hiring entity reviewing applications for a role. Content items 112 pertaining to an application may include résumés, curricula vitae, job applications, job requisitions, performance appraisals, letters of intent, letters of recommendation, emails, chat applications, and others. In this example, text data in a content item 112 may recite a skill. A skill is any information that may be relevant to processing an application. Examples of skills may include expertise, experiences, qualifications, abilities, degrees, certifications, and others. The skills recited in content items 112 may be expressed in skill phrases. Examples of skill phrases may include “I have led a team of engineers,” “deeper experience with neural networks will be helpful,” “managed an international team,” “performed leadership functions,” “experience managing 10-figure budgets,” “completed a course on computer-literacy,” “treating pulmonary oedemas,” “proficient in Microsoft Excel,” “executed marketing plans,” and others. Content item 112 may be obtained from multiple sources. For instance, a résumé might originate from a candidate, a job requisition might originate from a hiring manager, and a performance appraisal might originate from a third party. In this example, data repository 110 may store content items 112 that pertain to many applications.

In an embodiment, data corpus 114 may be a source of text data. For example, data corpus 114 may be a source of substitute words. A substitute word may be used to replace a target word in a target phrase. Data corpus 114 may include public and/or private sources. Examples of public sources may include dictionaries, websites (e.g., Wikipedia), newspaper articles, etc. It is impractical for a human to manually survey a large data corpus 114 to identify potential substitute words for any target word that may be expected to appear in a content item 112. A data corpus 114 may be tailored to a particular application of a system 100. For example, if content items 112 are expected to pertain to applications for a role(s) in a particular industry, data corpus 114 may be drawn from data sources pertaining to the particular industry. A data corpus 114 may be chosen to reflect an industry, vocation, technical space, geographic location, demographic, dialect, and/or other information. Data corpus 114 may include content items 112.

In an embodiment, API 120 may facilitate communications between components of system 100 and/or components external to system 100. For example, data repository 110 may be configured to “push” data to content processing component 130 via API 120 using a set of credentials. In another example, content processing component 130 may be configured to retrieve data from data repository 110 by “pulling” the data via API 120 using a set of credentials.

In an embodiment, content processing component 130 may process content items 112. Processing a content item 112 may entail identifying a target phrase included in the content item 112 and converting the target phrase to generate a standard phrase. As an example, consider a hiring entity reviewing applications for a role. Evaluating an application may require identifying skills expressed in skill phrases found within content items 112 that pertain to the application. For instance, evaluating an application may require determining if a skill that is recited in one content item 112 (e.g., a job requisition) is also present in another content item 112 (e.g., a résumé). However, any two content items 112 pertaining to an application may be formatted differently, may be written by different authors, and may be written from differing perspectives of the application process. Consequently, any given skill may be expressed in a myriad of different ways. For example, a job requisition may recite “must be proficient in Java,” a résumé may recite “20 years of hands-on experience with Java,” and a cover letter may recite “I have guru-level knowledge of Java.” In this example, a skill phrase may be a target phrase, and content processing component 130 may convert the skill phrase to generate a standard phrase for expressing the skill. It is impractical for a human to manually standardize phrases in the content items. For example, a hiring entity may need to process vast numbers of applications prior to selecting a candidate for a role. Embodiments define a sequence of system-executed operations for standardizing target phrases that differ from how a human would manually attempt to standardize the phrases.

As illustrated in FIG. 1, content processing component 130 may include data corpus surveyor 132, phrase identifier 134, phrase converter 136, machine learning model 138, and/or other components.

In an embodiment, data corpus surveyor 132 may survey a data corpus 114 for words that may be used as substitute words. Data corpus surveyor 132 may survey a data corpus 114 that is tailored to a particular application of system 100. For example, if content items 112 received by system 100 include phrases, such as “excising lung nodules,” “treating acute pulmonary oedemas,” “interpreting lab results,” etc., data corpus surveyor 132 may survey a data corpus 114 relating to medicine.

In an embodiment, data corpus surveyor 132 may generate a list of words identified in a data corpus 114. For example, data corpus surveyor 132 may generate a list of nouns identified in a data corpus 114. An entry in a list of nouns may identify a noun, a frequency that the noun occurs in the data corpus 114, other contextual information relating to a noun's occurrence(s) within the data corpus 114 (e.g., an industry setting), and/or other information. A verb form of a noun may be counted towards a recorded frequency of the noun's occurrence in a data corpus 114. A frequency of a noun occurring in a data corpus 114 may be a weighted frequency. For example, an occurrence of a word in one data source may be weighted differently than an occurrence of the word in another data source. Content items 112 may be included in a data corpus 114 surveyed by data corpus surveyor 132. Consequently, processing a content item 112 may result in an update to a list of nouns. A list of nouns may be organized alphabetically and/or in another manner. An alphabetical order of nouns in a list of nouns may be ascending or descending.

In an embodiment, phrase identifier 134 may identify a target phrase for standardization. Criteria for identifying a target phrase may be tailored to an application of system 100. For example, in an application of system 100, a target phrase may be a verb-centered phrase (e.g., “executing marketing plans”) that is to be standardized into a noun-centered phrase (e.g., “execution of marketing plans”). In another example, a target phrase may be a noun-centered phrase that may be standardized into a verb-centered phrase. In yet another example, a target phrase may be restructured to conform with a standard phrase structure. In yet another example, a target phrase may be standardized into a different tense. For instance, a target phrase may be expressed in a past tense, and a corresponding standard phrase may be expressed in a present tense. In yet another example, a target phrase may include a word that is replaced by a synonym or near-synonym. For instance, if the word “teacher” occurs more frequently than “mentor” in a data corpus 114, a target phrase may be “mentor of colleagues” and a standard phrase may be “teacher of colleagues.”

In an embodiment, phrase identifier 134 may identify a target word for replacement with a substitute word. As an example, assume that a standard phrase is a noun-centered phrase. In this example, a corresponding target phrase may be identified based on the target phrase including a verb that is to be replaced by a substitute noun. However, it may not be evident if a word in a phrase is a verb. For instance, consider the phrase “detailed evaluation report.” The word “detailed” could either be a verb or an adjective depending on the context. Moreover, not every verb in a phrase may be replaced, and a verb that is to be replaced may be situated anywhere in a phrase. To determine if a word in a phrase is a target word, phrase identifier 134 may consider contextual information pertaining to the word. Contextual information pertaining to a word in a phrase may include the positioning of the word in the phrase, a structure of the phrase, text adjacent to the word, a meaning of the phrase, a setting that the word and phrase originate from, a definition(s) of the word, the characteristics of the content item 112 that the phrase appears in, and/or other information.

In an embodiment, target phrase identifier 134 may generate a list of target words. The words in a list of target words may be compiled from content items 112. In an example, target phrase identifier 134 may generate a list of verbs that may be replaced by substitute nouns. An entry in a list of verbs may identify a verb, contextual information pertaining to the occurrence(s) of the verb in a content item 112, and/or other information. A list of verbs may be organized alphabetically and/or in another manner. An alphabetical order of verbs in a list of verbs may be ascending or descending.

In an embodiment, phrase converter 136 may convert a target phrase to generate a standard phrase. Converting a target phrase to generate a standard phrase may entail replacing a target word(s) with a substitute word(s), restructuring the target phrase based on a standard phrase structure, and/or other operations. Restructuring a target phrase may involve reordering a word(s) within the target phrase, adding a word(s) to the target phrase, deleting a word(s) from the target phrase, altering punctuation of the target phrase, and/or other alterations.

In an embodiment, phrase converter 136 may replace a target word with a substitute word. For example, phrase converter may replace a verb in a target phrase with a substitute noun. A substitute noun may be a noun form of the verb that the substitute noun replaces. For instance, the verb “organizing” might be replaced with the substitute noun “organization.” Additionally, or alternatively, phrase converter 136 may replace a verb with a substitute noun that is synonymous or near synonymous in meaning. For instance, the verb “expediting” might be replaced with the substitute noun “acceleration.” A substitute noun may be selected from a candidate subset of nouns to replace a verb.

In an embodiment, phrase converter 136 may identify a candidate subset of word(s) to replace a target word. For example, phrase converter 136 may identify a candidate subset of nouns to replace a verb in a target phrase. A word may be included in a candidate subset of words based on a comparison between the word and the target word. For example, phrase converter 136 may include a noun in a candidate subset of nouns to replace a verb based on a comparison between the noun and the verb. A comparison between words may be a comparison of the characters in the words. For example, if a noun includes a sequence of characters that matches a sequence of characters in a verb, the noun may be added to a candidate subset of nouns to replace the verb. Unlike any manual human-implemented standardization process, the system may, for example, compare a subset of characters of a verb to a plurality of nouns extracted from a data corpus 114. Phrase converter 136 may select a subset of characters of a target word for comparison with other words. For example, phrase converter 136 may select a subset of characters of a verb for comparison with a noun. A subset of characters may include every character of a target word. The number of characters included in a subset of characters may depend on the length of a target word. In an example, the length of a verb may be multiplied by a value to determine the number of characters included in a subset of characters. For instance, if the value is 0.75, and if the verb is “teaching,” “teachi” may be a subset of characters. In this example, the value may be a predetermined constant, or the value may be adjusted for and/or during applications of system 100. Phrase converter 136 may additionally, or alternatively, employ other criteria for determining a subset of characters. For example, phrase converter 136 may shorten a subset of characters to exclude characters of a suffix (e.g., the suffix of a gerund). In this example, if the verb is “teaching,” “teach” may be a subset of characters.

In an embodiment, phrase converter 136 may compare a target word to a list of words to identify a candidate subset of words to replace the target word. For example, phrase converter 136 may draw a candidate subset of nouns from a list of nouns identified in a data corpus 114. If no candidate nouns are found, phrase converter 136 may utilize a gerund version of the verb as an alternative substitute, call for a list of nouns to be expanded, call for a new list of nouns to be generated, utilize a substitute noun that is synonymous or nearly-synonymous to the verb as an alternative substitute, query a generative AI model for a noun form of the verb or for a conversion of the target phrase, and/or take other actions. It should be noted that a gerund (e.g., “processing”) may be a noun depending on the use of the gerund in the phrase. For example, “processing” may be a verb in the target phrase “processing analytics data.” However, “processing” may be a noun in the standard phrase “processing of analytics data.”

In an embodiment, phrase converter 136 may execute a binary search(es) to identify a word in a list of words that matches a target word. For example, phrase converter 136 may execute a binary search on a list of nouns to identify a noun matching a verb. A binary search of an ordered list of words may reduce the number of words that are searched by approximately fifty percent. Phrase converter 136 may execute multiple binary searches prior to identifying a matching word. A binary search may be based on a subset of characters of a word. Data yielded from a binary search for a matching word may be saved to narrow the scope of subsequent searches. Consider, for example, a list of nouns organized in an ascending alphabetical order. A binary search of the list of nouns may reveal that the noun “management” is approximately in the middle of the alphabetical list of nouns. Consequently, the nouns below “management” may be excluded from a subsequent search for a noun matching the verb “leading.” The nouns above “management” in the alphabetical list of nouns may be excluded from a subsequent search for a noun matching the verb “notify.”

In an embodiment, phrase converter 136 may compare an ordered list of target words to a list of words identified in a data corpus. Comparisons may proceed in a sequence that corresponds to the order of the list of target words. For instance, phrase converter 136 may compare an alphabetical list of verbs to a list of nouns. The verbs may be compared to the list of nouns in a sequence that corresponds to the alphabetical order of the list of verbs. As an example, assume that the verb “managing” is immediately followed by the verb “mediate” in a list of verbs. A candidate subset of nouns to replace “managing” may be drawn from the list of nouns prior to the verb “mediating” being compared to the list of nouns.

In an embodiment, phrase converter 136 may compare a target word to an ordered list of words. Comparisons to the target word may proceed in a sequence that corresponds to the order of the list of words. For instance, phrase converter 136 may compare a verb of a target phrase to an alphabetical list of nouns. Comparisons between the verb and the nouns in the list of nouns may proceed in a sequence that corresponds to the alphabetical order of the list of nouns. As an example, assume that the noun “abatement” is immediately followed by the noun “act” in the list of nouns. In this example, a verb may be compared to “abatement.” After being compared to “abatement,” “act” may be the next noun that the verb is compared to.

In an embodiment, phrase converter 136 may compare a target word to a portion of a list words. If the words that match a target word occur in a contiguous sequence within a list of words, the search for matching words may cease after the contiguous sequence of matching words is identified. For instance, depending on a verb, the noun forms of the verb may be expected to occur contiguously within an alphabetical list of nouns. As an example, consider the verb “processing.” A corresponding subset of characters may be “process.” A contiguous sequence of nouns in an alphabetical list of nouns might include “process,” “processing,” “processor,” and “provide.” The nouns “process,” “processing,” and “processor” may be included in a candidate subset of nouns. However, it may be that no more matching nouns are expected to be found in the remainder of the list. Thus, “provide” may be the last noun in the list of nouns that the candidate subset “process” is compared to. A binary search(es) may be executed to identify a contiguous sequence of matching nouns.

In an embodiment, phrase converter 136 may compare an alphabetical list of target words to an alphabetical list of words identified in a data corpus. For instance, phrase converter 136 may compare an alphabetical list of verbs to an alphabetical list of nouns. Phrase converter 136 may compare a verb with the last noun that an immediately preceding verb in the list of verbs is compared to. As an example, assume that, in a list of verbs, the verb “managing” is immediately followed by the verb “mediate.” Further assume that, in a list of nouns, the noun “manager” is immediately followed by the noun “market.” If “market” is the last noun that the verb “managing” is compared to, “market” may be the first noun that the verb “mediate” is compared to. In this way, phrase converter 136 may reduce the number of comparisons that will be executed to generate a candidate subset of nouns for each verb in the list of verbs, thereby reducing computational complexity.

In an embodiment, phrase converter 136 may select a substitute word from a candidate subset of words to replace a target word. For example, phrase converter 136 may select a substitute noun from a candidate subset of nouns to replace a verb in a target phrase. If a candidate subset of words includes a single word, then the single word is selected as a substitute word. However, it may be that a candidate subset of words contains multiple words. For example, a candidate subset of nouns for the verb “administer” might include “admin,” “administrator,” “administration,” “administrant,” and “administratrix.” In this example, phrase converter 136 may consider various criteria when selecting a substitute noun. For instance, phrase converter 136 may select the noun in the candidate subset of nouns that occurs most frequently in data corpus 114. Additionally, or alternatively, phrase converter 136 might consider other contextual information. For instance, the context that the verb originates from may be compared with the context that a noun originates from. It is impractical for a human to manually standardize phrases in content items using nouns extracted from a data corpus 114 based in part on a frequency and/or context of each noun in the data corpus 114.

In an embodiment, phrase converter 136 may identify duplicate words in a list of target words. For instance, phrase converter 136 may identify duplicate verbs in a list of verbs generated by phrase identifier 134. As used herein, a “duplicate word” may refer to a word that is identical to another word or a word that includes a subset of characters that is identical to a subset of characters of another word. As an example, assume that phrase converter 136 generates a candidate subset of nouns for the verb “mediating” and selects a substitute noun from the candidate subset of nouns. In this example, if a subsequent verb in the list of verbs is a duplicate of “mediating,” phrase converter 136 may reuse the substitute noun that was previously selected. Alternatively, phrase converter 136 may select a different substitute noun from the previously generated candidate subset of nouns.

In an embodiment, phrase converter 136 may restructure a target phrase. Restructuring a target phrase may entail changing the position of a word(s) within the phrase. For example, consider the target phrase “provide instruction to on-call residents.” Phrase converter 136 may replace the verb “provide” with the substitute noun “provision,” and the words in the target phrase may be restructured to generate the standard phrase “instruction provision to on-call residents.” Additionally, or alternatively, restructuring a target phrase may entail adding a word to a phrase. For example, consider the target phrase “data analyzing.” Phrase converter 136 may replace “analyzing” with “analysis,” add the preposition “of,” and reorder the words within the phrase to generate the standard phrase “analysis of data.” It should be understood that phrase converter 136 may restructure a target phrase without also replacing a target word within the phrase. For example, consider the target phrase “managing a team of engineers.” Phrase converter 136 may add the preposition “of” to generate the standard phrase “managing of a team of engineers.”

In an embodiment, machine learning model 138 may be applied to a target word to predict a contextual setting associated with the target word. For example, machine learning model 138 may predict an industry associated with a verb of a target phrase in a content item 112. Inputs to machine learning model 138 may include any data and/or metadata of a content item(s) 112, data determined by the system 100, and/or other information. Machine learning model 138 may be trained with training data. An example set of training data may include a content item 112 that includes a set of verb(s) and an industry that is associated with the content item 112. Feedback regarding predictions output by machine learning model 138 may be obtained from a user of system 100 and/or other sources. Feedback obtained by system 100 may be used to further train machine learning model 138.

In one or more embodiments, a machine learning algorithm is an algorithm that can be iterated to train a target model f that best maps a set of input variables to an output variable. In particular, a machine learning algorithm may be configured to generate and/or train machine learning model 138.

A machine learning algorithm is an algorithm that can be iterated to train a target model/that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, that in turn updates the target model f.

A machine learning algorithm may generate a target model f such that the target model/best fits the datasets of training data to the labels of the training data. Additionally, or alternatively, a machine learning algorithm generates a target model f such that when the target model f is applied to the datasets of the training data, a maximum number of results determined by the target model/matches the labels of the training data. Different target models be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In one or more embodiments, an “interface” (not pictured) may refer to hardware and/or software configured to facilitate communications between a user and system 100. An interface may render user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an interface may be specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, an interface may be specified in one or more other languages, such as Java, C, or C++.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, a tenant is a corporation, organization, enterprise, or other entity that accesses a shared computing resource.

Additional embodiments and/or examples relating to computer networks are described below in Section 5, titled “Computer Networks and Cloud Networks.”

### 3. Standardizing Text Data

FIG. 2 illustrates an example set of operations for standardizing text data in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In operation 202, a target phrase for standardization may be identified in a content item. A target phrase may be identified based on various criteria. In an example, a phrase may be a target phrase if the phrase includes a target word. A target word may be a verb that is replaced with a noun, a noun that is replaced by a verb, a word that is replaced with a synonym (e.g., “mentoring” may be replaced with “teaching”), a word that is replaced with a different tense of the word, and/or a word that is replaced for other reasons. Whether or not a word is a target word may depend on the position of the word within a phrase. As an example, assume that a standard phrase is a noun-centered phrase. In this example, a corresponding target phrase may be a verb-centered phrase. A phrase may be a verb-centered phrase if the phrase begins or ends with a verb. Thus, a target phrase may be identified based on the target phrase beginning or ending with a verb. Additionally, or alternatively, a phrase may be a target phrase if the phrase does not comply with a standard phrase structure. Restructuring a target phrase may entail rearranging words within the phrase, adding words to the phrase, removing words from the phrase, altering punctuation of the phrase, and/or other alterations. A target phrase that is restructured may not contain a target word. For example, the noun-centered phrase “pain treatment” may be a target phrase and “treatment of pain” may be a corresponding standard phrase.

In operation 204, the system may proceed to another operation based on determining if a word in a target phrase is to be replaced with a substitute word. If a target phrase includes a target word (YES in operation 204), the system may proceed to operation 206. For example, if a target phrase includes a verb that is to be replaced by a substitute noun, the system may proceed to operation 206. Alternatively, if the target phrase does not include a target word (NO in operation 204), the system may proceed to operation 210. For instance, if a target phrase will be restructured to conform with a standard phrase structure but does not include a target word, the system may proceed to operation 210.

In operation 206, a candidate subset of words may be generated. A word may be included in a candidate subset of words based on the word being a candidate to replace a target word. For example, a noun may be added to a candidate subset of nouns to replace a verb if the noun is a noun form of the verb and/or is synonymous or similar in meaning to the verb. A candidate subset of words may be drawn from a list of words identified data corpus. For example, a candidate subset of nouns may be compiled from a list of nouns identified in a data corpus.

A word may be added to a candidate subset of words based on a comparison between the word and a target word. For example, a noun may be included in a candidate subset of nouns based on a comparison between the noun and a verb of the target phrase. If the verb in the target phrase is to be replaced with a noun form of the verb, the characters of the verb may be compared with the characters of nouns in the list of nouns. In this scenario, a subset of characters of the verb may be selected for comparison to the list of nouns. The subset of characters may include one or more characters of the verb. The subset of characters may include every character of the verb. If the subset of characters matches a sequence of characters in a noun, the noun may be added to the candidate subset of nouns.

Generating a candidate subset of words to replace a target word may involve a series of comparisons to the target word. For example, a verb in a target phrase may be compared to a series of nouns in a list of nouns. The list of nouns may be organized alphabetically, and the series of comparisons may proceed in a sequence that corresponds to the alphabetical order of the list of nouns. Additionally, or alternatively, a binary search may be executed on the list of nouns. Data yielded from a binary search may be saved. Previously searched verbs and matching nouns may serve as pointers within a list of nouns. The pointers may serve as starting and ending points for subsequent comparisons to the list of nouns.

Identifying a candidate subset of nouns to replace a verb may not require that the verb be compared with every noun in the list of nouns. It may be that nouns matching the verb occur contiguously within a list of nouns. Matching nouns may be expected to occur contiguously within a list of nouns if the list of nouns is organized alphabetically. In this scenario, if comparisons with the list of nouns occur in a sequence that follows the alphabetical order of the list, comparisons between the verb and the list of nouns may cease at the first non-matching noun that follows a matching noun in the list of nouns. As an example, consider the verb “managing.” A corresponding subset of characters may be “manag,” and a list of nouns may include “manage,” “management” and “mandate” in contiguous succession. Due to the list of nouns being ordered alphabetically, it may be that no more matching nouns are expected to be found within the list of nouns after “management.” As such, ceasing comparisons to “manag” may prevent excess computations being executed. If no noun in the list of nouns is found to match the verb, a gerund version of the verb may be used as an alternative substitute, a noun that is synonymous or nearly-synonymous to the verb may be used as an alternative substitute, the list may be expanded, a new list may be generated, a generative AI model may be prompted to replace the verb or to standardize a target phrase that the verb originates from, and/or other operations may occur.

In operation 208, a substitute word may be selected from a candidate subset of words. If a candidate subset of words contains a single word, the single word is selected as the substitute word. However, in other scenarios a candidate subset of words may contain multiple words. In an example, a candidate subset of nouns may be composed with multiple noun forms of a verb. For instance, a candidate subset of nouns to replace the verb “managing” may include “manage,” “management,” “manager,” and “managing.” As such, the system may select a substitute noun from the candidate subset based on various criteria. For instance, a substitute noun may be selected based on how frequently the substitute noun occurs in a data corpus relative to the other nouns in a candidate subset of nouns. Additionally, or alternatively, the system might consider other contextual information. For instance, a context that a verb originates from may be compared with a context that a noun originates from.

Additional embodiments and/or examples relating to selecting a noun to replace a verb are described below in Section 4.1, titled “Selecting a Substitute Noun.”

In operation 210, a standard phrase may be generated. Converting a target phrase to generate a standard phrase may entail replacing a target word with a substitute word selected in an occurrence of operation 208. For example, converting a target phrase may entail replacing a verb with a substitute noun. Converting a target phrase may entail replacing multiple target words. Additionally, or alternatively, converting a target phrase may entail restructuring the target phrase. Restructuring a target phrase may entail adding a word(s) to the target phrase, deleting a word(s) from the target phrase, rearranging a word(s) within the target phrase, altering punctuation of the target phrase, and/or other alterations. For example, a standard phrase structure may define the position of a preposition type relative to a noun type. As such, restructuring a target phrase may entail adding a preposition to a target phrase and/or rearranging a noun relative to a preposition within the target phrase.

Additional embodiments and/or examples relating to converting a target phrase to generate a standard phrase are described below in Section 4.2, titled “Generating a Standard Phrase.”

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

### 4.1 Selecting a Substitute Noun

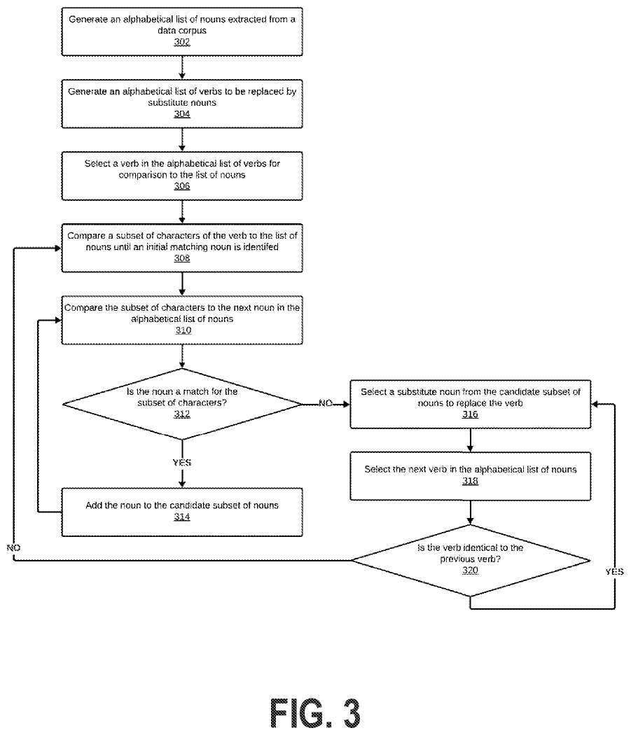

FIG. 3 illustrates an example set of operations for selecting a substitute noun in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In operation 302, a list of noun(s) may be generated. Nouns included in the list of nouns may be obtained from a data corpus. An entry in the list of nouns may identify a noun, the frequency that the noun occurred in the data set, contextual information relating to the nouns occurrence(s) within the data corpus (e.g., an industry setting), and/or additional information. The list of nouns may be organized according to an alphabetical order of the nouns included in the list.

In operation 304, a list of verb(s) may be generated. A verb included in the list of verbs may have been identified in a target phrase of a content item. The list of verbs may include multiple verbs identified in multiple content items. An entry in the list of verbs may identify a verb, contextual information relating to the occurrence of the verb in a content item, and/or additional information. The list of verbs may be organized according to an alphabetical order of the verbs included in the list.

In operation 306, a verb in the list of verbs may be selected for comparison to the list of nouns. As an example, assume that a verb selected for comparison to the list of nouns in this operation is “administer.” The system may select a subset of characters for comparison to the list of nouns. The subset of characters may include the first letter of the verb. In this example, the subset of characters may be “administ.”

In operation 308, a verb may be compared with the list of nouns until an initial matching noun is identified. An initial matching noun may be added to a candidate subset of nouns. As an example, assume that the list of nouns includes the following ten nouns: “abate,” “abatement,” “account,” “addition,” “address,” “administrant,” “administration,” “administrator,” “advance,” and “zone.” In this example, the initial matching noun for the verb “administering” is “administrant.” Upon being identified as a matching noun, the noun “administrant” may be added to a candidate subset of nouns to replace the verb “administering.” Prior to identifying the initial matching noun, the subset of characters “administ” may be initially compared to “abate” followed by “abatement,” “account,” “addition,” and “address.” Alternatively, a binary search may be employed. If a binary search is applied to an alphabetical list of nouns having a number “n” of nouns, a verb may be compared to a noun that is approximate to n/2 in the alphabetical list of nouns. Thus, in this example, the subset of characters “administ” would be initially compared to “address.” Based on the comparison to “address,” a half of the list of nouns would be selected for continuing the search. In this example, because “administ” is alphabetically less than “address” (i.e., “address” occurs before “administ” in an ascending alphabetical order), the latter half of the list of nouns would be selected, and the nouns “abate” through “address” would be excluded from the search for matching nouns. Subsequent comparisons may proceed sequentially from “address,” or additional binary searches may be executed to further narrow the list of nouns.

In operation 310, a verb may be compared with another noun in a list of nouns. A verb may be compared to a noun in the list of nouns that immediately follows the previous noun that the verb is compared to. As an example, further consider the list of ten nouns described above. If the subset of characters “administ” was most recently compared to the noun “administrant,” the subset of characters “administ” may be compared to the noun “administration” in this operation.

In operation 312, the system may proceed to another operation based on whether or not the most recent occurrence of operation 310 resulted in identifying a matching noun. If the noun that is compared with a verb in the most recent occurrence of operation 310 is a match (YES in operation 312), the system may proceed to operation 314. For example, if the subset of characters “administ” was compared to “administration” in the most recent occurrence of operation 310, the system may proceed to operation 314. Alternatively, if the noun that is compared with a verb in the most recent occurrence of operation 310 is not a match (NO in operation 312), the system may proceed to operation 316.

In operation 314, a noun that is compared to a verb in the most recent occurrence of operation 310 may be added to a candidate subset of nouns. For example, if the subset of characters “adminst” was most recently compared to the noun “administration,” “administration” may be added to a candidate subset of nouns in this operation.

In operation 316, a substitute noun may be selected to replace a verb in a target phrase. The substitute noun may be selected from a candidate subset of nouns. As an example, further consider the list of ten nouns described above. In this example, a candidate subset of nouns for the verb “administer” may include “administrant,” “administration,” and “administrator.” The substitute noun that is selected may be the noun in the candidate subset of nouns that most frequently occurred in a data corpus. Additionally, or alternatively, other contextual information may be considered. For example, an industry setting that the verb “administer” occurred in may be compared to the industry setting that a noun in the candidate subset of nouns occurred in.

In operation 318, another verb from the list of verbs may be selected for comparison to the list of nouns. The verb selected may be the verb in the alphabetical list of verbs that immediately follows the verb most recently compared to the list of nouns. As an example, assume that the verb “administer” is immediately followed by the verb “advertise” in the list of verbs. If “administer” is the verb most recently compared to the list of nouns, the verb “advertise” may be selected in this operation.

In operation 320, the system may proceed to another operation based on a comparison between two verbs. If the verb selected in the most recent occurrence of operation 318 is a duplicate of a verb previously compared to the list of nouns (YES in operation 320), the system may return to operation 316. In this scenario, the substitute noun that was previously selected to replace the duplicate verb may also be selected to replace the present verb. Alternatively, if the verb selected in the most recent occurrence of operation 318 does not match a verb previously compared to the list of nouns (NO operation 320), the system may return to operation 308.

### 4.2 Generating a Standard Phrase

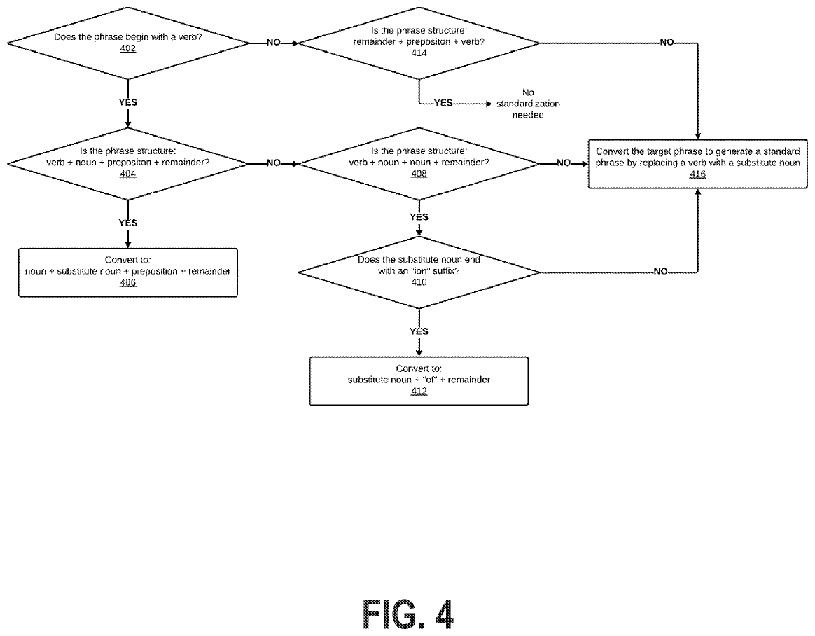

FIG. 4 illustrates an example set of operations for generating a standard phrase in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In operation 402, the system may proceed to another operation based on determining if a phrase begins or ends with a verb. If the system determines that a phrase begins with a verb (YES in operation 402), the system may proceed to operation 404. Alternatively, if the system determines that the phrase ends with a verb (NO in operation 402), the system may proceed to operation 414.

In operation 404, the system may proceed to another operation based on determining the structure of a phrase. If a phrase is structured such that a verb is followed by a noun, the noun is followed by a preposition, and the preposition is followed by any remainder of the phrase (YES in operation 404), the system may proceed to operation 406. For example, if a phrase is “provide leadership to a team of peers,” the system may proceed to operation 406. Alternatively, if the phrase possesses a different structure (NO in operation 404), the system may proceed to operation 408.

In operation 406, the system may convert a target phrase to generate a standard phrase. In this example operation, converting the target phrase may entail replacing a verb with a substitute noun and reordering words within the target phrase. A resulting standard phrase may be structured such that a noun is followed by the substitute noun, the substitute noun is followed by a preposition, and the preposition is followed by any remainder of the phrase. For example, if a target phrase is “provide leadership to a team of peers,” the target phrase may be converted to generate the standard phrase “leadership provision to a team of peers.”

In operation 408, the system may proceed to another operation based on determining the structure of a phrase. If a phrase is structured such that a verb is followed by a noun, the noun is followed by another noun, and the other noun is followed by any remainder of the phrase (YES in operation 408), the system may proceed to operation 410. For example, if a phrase is “execute advertisement plans,” the system may proceed to operation 410. Alternatively, if the phrase has a different structure (NO in operation 408), the system may proceed to operation 416.

In operation 410, the system may proceed to another operation based on determining the characteristics of a substitute noun. If a substitute noun ends with the suffix “ion” (YES in operation 410), the system may proceed to operation 412. For example, if the substitute noun is “execution,” the system may proceed to operation 412. Alternatively, if the substitute noun does not end with an “ion” suffix (NO in operation 410), the system may proceed to operation 416. For example, if the substitute noun is a gerund (e.g., “executing”), the system may proceed to operation 416.

In operation 412, the system may convert a target phrase to generate a standard phrase. In this example operation, converting the target phrase may entail replacing a verb with a substitute noun and/or adding a preposition to the target phrase. A resulting standard phrase may be structured such that the substitute noun is followed by the additional preposition, and the additional preposition is followed by any remainder of the phrase. For instance, a target phrase “execute advertisement plans” may be converted to generate the standard phrase “execution of advertisement plans.”

In operation 414, the system may proceed to another operation based on determining the structure of a phrase. If a phrase is structured such that a remainder of the phrase is followed by a preposition and the preposition is followed by a verb (YES in operation 414), the phrase may not be altered. For example, if the phrase is “demonstrated ability to lead,” the phrase may be left as is. It should be noted that the word “demonstrated” in the phrase “demonstrated ability to lead” may be an adjective rather than a verb. Alternatively, if the phrase has a different structure (NO in operation 414), the system may proceed to operation 416. For example, if the phrase is structured such that a remainder of the phrase is followed by a noun and the noun is followed by a verb (e.g., “application infrastructure upgrading”), the system may proceed to operation 416.

In operation 416, the system may convert a target phrase to generate a standard phrase. In this example operation, converting the target phrase may entail replacing a verb with a substitute noun. For example, a target phrase “application infrastructure upgrading” may be converted to generate a standard phrase “application infrastructure upgradation.”

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread). A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, the database may be shared by multiple tenants.

In an embodiment, a subscription list indicates the applications that the different tenants have authorization to access. For each application, a list of tenant IDs of tenants authorized to access the application is stored. A tenant is permitted access to a particular application if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications that are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other clement of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### 6.1 Triggers

The techniques described above may be encapsulated into a microservice according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information pertaining to the satisfied trigger condition. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 6.2 Actions

In one or more embodiments, a plugged-in microservice application may expose actions to the microservices manager. The exposed actions may receive, as input, data or an identification of a data object or location of data that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

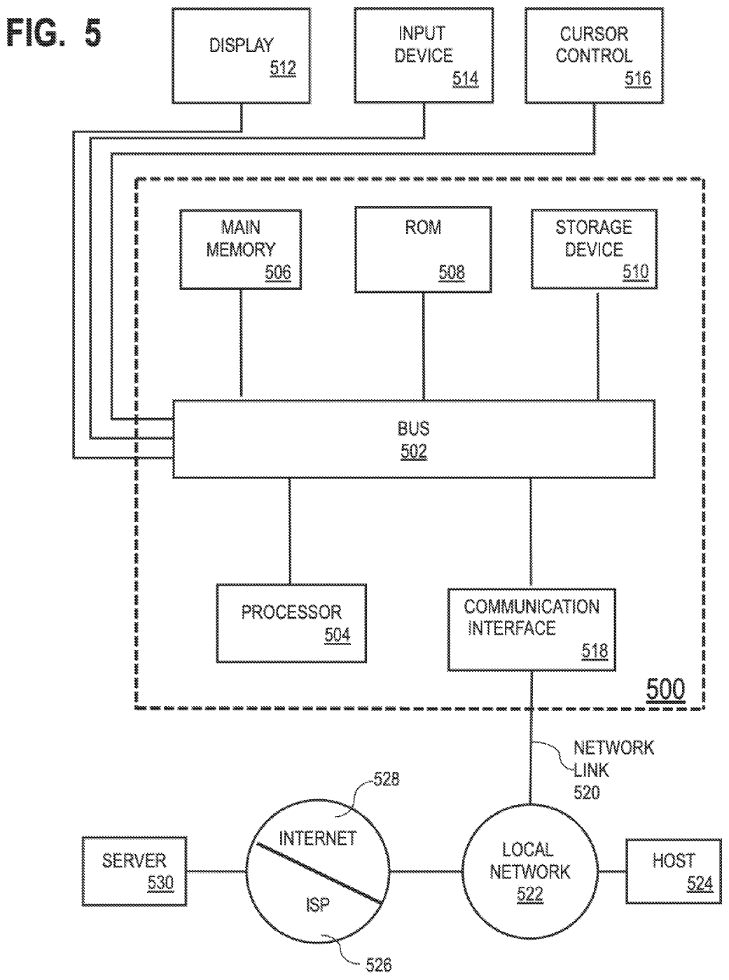

For example, FIG. 5 is a block diagram that illustrates a computer system 500 that an embodiment of the disclosure may be implemented upon. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic that in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506. Processor 504 retrieves and executes the instructions from main memory 506. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518 that carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as the code is received, and/or stored in storage device 510, or other non-volatile storage for later execution.

### 8. Miscellaneous; Extensions

Unless otherwise defined, terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form that such claims issue, including any subsequent correction.

What is claimed is:

1. One or more non-transitory computer-readable media comprising instructions that, when executed by one or more hardware processors, cause performance of operations comprising:
identifying a first target phrase of a content item;
selecting a first subset of characters of a first verb, comprised within the first target phrase, for comparison with a plurality of nouns extracted from a data corpus for a phrase conversion process;
comparing the first subset of characters, of the first verb, to the plurality of nouns;
identifying a first candidate subset of one or more nouns, of the plurality of nouns, that includes a sequence of characters that match the first subset of characters of the first verb;
selecting a particular noun, of the first candidate subset of one or more nouns, based on a frequency associated with the particular noun within the data corpus; and
converting the first target phrase of the content item to a first standard phrase at least by replacing the first verb within the first target phrase with the particular noun.

2. The one or more non-transitory computer-readable media of claim 1, wherein the operations further comprise: prior to selecting the first subset of characters of the first verb, selecting the first verb for the phrase conversion process responsive to determining that the first verb is positioned as an initial word or final word of the first target phrase.

3. The one or more non-transitory computer-readable media of claim 1, wherein the operations further comprise: selecting a number of characters to include in the first subset of characters based on a total number of characters in the first verb and a target percentage value to be applied to the total number of characters.

4. The one or more non-transitory computer-readable media of claim 1, wherein the particular noun is selected based further on an industry associated with the first verb, wherein the operations further comprise:
obtaining training datasets for training a machine learning model, a training dataset of the training datasets comprising:
a content item comprising a set of verbs;
an industry associated with the content item;
training the machine learning model based on the training datasets to predict industries associated with verbs;
applying the machine learning model to the first verb to predict the industry associated with the first verb.

5. The one or more non-transitory computer-readable media of claim 1, wherein the first target phrase is converted to the first standard phrase further by reordering a set of words within the first target phrase, after replacing the first verb within the first target phrase with the particular noun, based on a standard phrase structure.

6. The one or more non-transitory computer-readable media of claim 5, wherein the standard phrase structure defines a positioning of a preposition type relative to a noun type, and wherein reordering the set of words within the first target phrase comprises reordering a preposition and a noun within the set of words in accordance with the positioning of the preposition type relative to the noun type in the standard phrase structure.

7. The one or more non-transitory computer-readable media of claim 1, wherein the operations further comprise:
identifying a second target phrase of the content item;
selecting a second subset of characters of a second verb, comprised within the second target phrase, for comparison with the plurality of nouns for the phrase conversion process;
comparing the second subset of characters of the second verb with the first subset of characters of the first verb;
determining that the second subset of characters is identical to the first subset of characters; and
converting the second target phrase of the content item to a second standard phrase at least by replacing the second verb within the second target phrase with the particular noun.

8. The one or more non-transitory computer-readable media of claim 1, wherein the operations further comprise:
prior to identifying the first target phrase of the content item:
identifying a plurality of target phrases of the content item;
identifying a plurality of verbs comprised respectively within the plurality of target phrases;
sorting the plurality of verbs in a first alphabetical order; and
sorting the plurality of nouns in a second alphabetical order;
subsequent to selecting the particular noun:
selecting a second subset of characters of a second verb that is subsequent to the first verb in the first alphabetical order; and
comparing the second subset of characters of the second verb to a subset of the plurality of nouns, wherein the subset of the plurality of nouns comprises nouns subsequent to the particular noun in the second alphabetical order.

9. The one or more non-transitory computer-readable media of claim 8, wherein the first subset of characters, of the first verb, are compared to the plurality of nouns in a sequence that corresponds to the second alphabetical order until the first candidate subset of the one or more nouns has been identified.

10. The one or more non-transitory computer-readable media of claim 1, wherein identifying a first candidate subset of one or more nouns comprises applying a binary search algorithm to identify an initial noun of the first candidate subset of one or more nouns.

11. A method, comprising:
identifying a first target phrase of a content item;
selecting a first subset of characters of a first verb, comprised within the first target phrase, for comparison with a plurality of nouns extracted from a data corpus for a phrase conversion process;
comparing the first subset of characters, of the first verb, to the plurality of nouns;
identifying a first candidate subset of one or more nouns, of the plurality of nouns, that includes a sequence of characters that match the first subset of characters of the first verb;
selecting a particular noun, of the first candidate subset of one or more nouns, based on a frequency associated with the particular noun within the data corpus; and
converting the first target phrase of the content item to a first standard phrase at least by replacing the first verb within the first target phrase with the particular noun.

12. The method of claim 11, further comprising: prior to selecting the first subset of characters of the first verb, selecting the first verb for the phrase conversion process responsive to determining that the first verb is positioned as an initial word or final word of the first target phrase.

13. The method of claim 11, wherein the particular noun is selected based further on an industry associated with the first verb.

14. The method of claim 11, wherein the first target phrase is converted to the first standard phrase further by reordering a set of words within the first target phrase, after replacing the first verb within the first target phrase with the particular noun, based on a standard phrase structure.

15. The method of claim 14, wherein the standard phrase structure defines a positioning of a preposition type relative to a noun type, and wherein reordering the set of words within the first target phrase comprises reordering a preposition and a noun within the set of words in accordance with the positioning of the preposition type relative to the noun type in the standard phrase structure.

16. The method of claim 11, further comprising:
identifying a second target phrase of the content item;
selecting a second subset of characters of a second verb, comprised within the second target phrase, for comparison with the plurality of nouns for the phrase conversion process;
comparing the second subset of characters of the second verb with the first subset of characters of the first verb;
determining that the second subset of characters is identical to the first subset of characters; and
converting the second target phrase of the content item to a second standard phrase at least by replacing the second verb within the second target phrase with the particular noun.

17. The method of claim 11, further comprising:
prior to identifying the first target phrase of the content item:
identifying a plurality of target phrases of the content item;
identifying a plurality of verbs comprised respectively within the plurality of target phrases;
sorting the plurality of verbs in a first alphabetical order; and
sorting the plurality of nouns in a second alphabetical order;
subsequent to selecting the particular noun:
selecting a second subset of characters of a second verb that is subsequent to the first verb in the first alphabetical order; and
comparing the second subset of characters of the second verb to a subset of the plurality of nouns, wherein the subset of the plurality of nouns comprises nouns subsequent to the particular noun in the second alphabetical order.

18. The method of claim 17, wherein the first subset of characters, of the first verb, are compared to the plurality of nouns in a sequence that corresponds to the second alphabetical order until the first candidate subset of the one or more nouns has been identified.

19. The method of claim 11, wherein identifying a first candidate subset of one or more nouns comprises applying a binary search algorithm to identify an initial noun of the first candidate subset of one or more nouns.

20. A system comprising:
at least one device including a hardware processor;
the system being configured to perform operations comprising:
identifying a first target phrase of a content item;
selecting a first subset of characters of a first verb, comprised within the first target phrase, for comparison with a plurality of nouns extracted from a data corpus for a phrase conversion process;
comparing the first subset of characters, of the first verb, to the plurality of nouns;
identifying a first candidate subset of one or more nouns, of the plurality of nouns, that includes a sequence of characters that match the first subset of characters of the first verb;
selecting a particular noun, of the first candidate subset of one or more nouns, based on a frequency associated with the particular noun within the data corpus; and
converting the first target phrase of the content item to a first standard phrase at least by replacing the first verb within the first target phrase with the particular noun.
